(19) United States
(12) Patent Application Publication
(10) Pub. No.: US 2009/0025759 A1
(43) Pub. Date: Jan. 29, 2009

(54) WASHING APPARATUS FOR BASKETS, ESPECIALLY HANDHELD SHOPPING BASKETS AND THE LIKE

(75) Inventor: Jacobus Kotze, Kleinzee (ZA)

Correspondence Address: PEARNE & GORDON LLP, 1801 EAST 9TH STREET, SUITE 1200, CLEVELAND, OH, 44114-3108, US

(73) Assignees: Jacobus Kotze, Vredenburg, Northern Cape Province (ZA); Elmarie Visagie, Cape Town, Western Cape Province (ZA)

(21) Appl. No.: 12/294,174

(22) PCT Filed: Mar. 23, 2007
(86) PCT No.: PCT/IB07/00717

§ 371 Date: Sep. 23, 2008

(30) Foreign Application Priority Data
Mar. 24, 2006 (ZA) 2006/02408
Jan. 22, 2007 (ZA) 2007/00586

(51) Int. Cl. B08B 1/02; B08B 11/02; B08B 3/02

(52) U.S. Cl. 134/95.2; 134/127; 134/115 R; 134/104.2

(57) ABSTRACT

Washing apparatus is provided for handheld baskets, particularly shopping baskets, wherein a washing tunnel has an entrance end and an exit end and conveyor means for supporting baskets and conveying them from the entrance end to the exit end. A series of spray nozzles are arranged within the tunnel and connected to a source of cleaning liquid that is operatively under pressure. The conveyor means comprises a pair of laterally spaced conveyors arranged to move in unison whilst operatively supporting two opposite peripheral edges of a shopping basket in an inverted orientation as the basket is conveyed from the entrance end to the exit end. Retaining means such as a longitudinally extending skid or the like are provided over at least a part of the length of the tunnel to inhibit lifting of shopping baskets off the conveyors.

### FIELD OF THE INVENTION

This invention relates to washing apparatus for baskets such as handheld shopping baskets and commercially used baskets or crates used for conveying commodities both within a processing area and externally in order to ensure that clean and hygienic baskets are available for use.

It is to be understood that the term baskets as used herein is intended to include handheld shopping baskets as well as baskets or crates used for conveying commodities or, for that matter, for any other purpose.

### BACKGROUND TO THE INVENTION

Much attention has been given to the washing of supermarket trolleys and various different forms of apparatus have been proposed and produced for this dedicated purpose. As a general rule, such apparatus provides a track along which the trolleys can be moved whilst they remain supported on their own wheels. Such apparatus is therefore inappropriate to the washing of shopping or other baskets.

Prior Japanese patent publication JP 2003112135 describes the only apparatus of which applicant is aware that is dedicated to the washing of handheld shopping baskets. That apparatus provides an endless overhead conveyor on which the shopping baskets are suspended by their own handles. Such an apparatus cannot effectively wash the interior of many different types of baskets, particularly those made of injection moulded plastics material and that have perforated walls and bottoms connected by continuous imperforate plastic corners that are required for purposes of strength.

The only other mention of the washing of handheld shopping baskets of which applicant is aware is that contained in U.S. Pat. No. 3,022,791 that is directed primarily to a supermarket trolley washing apparatus having an elevated endless conveyor for moving the trolleys along a track whilst they are supported on their own wheels. The suggestion is, as in the case of the Japanese patent referred to above, that the handheld shopping baskets be suspended by their handles from the conveyor to pass through a washing zone.

As indicated, applicant considers that ineffective cleaning takes place when a shopping basket is suspended by its handle.

There are many other commercial situations, such as in the fish processing industry, the baskets or crates used to convey commodities from one point to other, particularly within a processing area, but also possibly to outside destinations where the baskets neatly clean and disinfected regularly.

### OBJECT OF THE INVENTION

It is the object of this invention to provide washing apparatus for baskets that is simple yet effective in its operation.

### SUMMARY OF THE INVENTION

In accordance with this invention there is provided a basket washing apparatus comprising a washing tunnel having an entrance end and an exit end, conveyor means for supporting baskets and conveying them from the entrance end to the exit end of the washing tunnel, and a series of spray nozzles arranged within the tunnel and connected to a source of cleaning liquid that is operatively under pressure, the apparatus being characterised in that the conveyor means comprises a pair of laterally spaced conveyors arranged to move in unison whilst operatively supporting two opposite peripheral edges of a basket in an inverted orientation as the basket is conveyed from the entrance end to the exit end, and in that retaining means are provided over at least a part of the length of the tunnel to inhibit lifting of baskets off the conveyors.

Further features of the invention provide for the laterally spaced conveyors to be link and pivot conveyors driven by co-operating sprockets with the conveyors preferably being made, at least predominantly, of injection moulded plastics components; for the conveyors to have upstanding flights at predetermined intervals along the length thereof so that the flights ensure movement of the periphery of a basket along the length of the washing tunnel; and for the retaining means to be one or more elevated skids extending over the path for baskets through the tunnel so as to cooperate with the now uppermost bottoms of the inverted baskets, in use.

Still further features of the invention provide for the washing apparatus to be mounted on a mobile chassis, conveniently a trailer chassis; for the washing tunnel to extend longitudinally along the length of the mobile chassis from one end to the other; for the mobile chassis to support a holding tank for a predetermined quantity of cleaning liquid; for the bottom of the tunnel to be formed into a collection facility for directing spent cleaning liquid back to the holding tank to thereby form a substantially closed circuit for the washing liquid; for the apparatus to have its own high-pressure pump for supplying cleaning liquid under pressure to the spray nozzles; for the high-pressure pump to be a multistage centrifugal pump; for suitable filter means to be included in the closed circuit for removing solid particles from the cleaning liquid, conveniently in an inlet arrangement to the high-pressure pump; and for the apparatus to include drying means, preferably an electric blower, for drying excess cleaning liquid from the baskets towards the exit end of the tunnel.

In order that the above and other features of the invention may become more apparent, one embodiment of washing apparatus according to the invention will now be described with reference to the accompanying drawings.

### BRIEF DESCRIPTION OF THE DRAWINGS

In the drawings:—

FIG. 1 is a schematic plan view of one embodiment of a trailer mounted washing apparatus according to the invention;

FIG. 2 is a schematic side view thereof; and,

FIG. 3 is a schematic rear end view thereof.

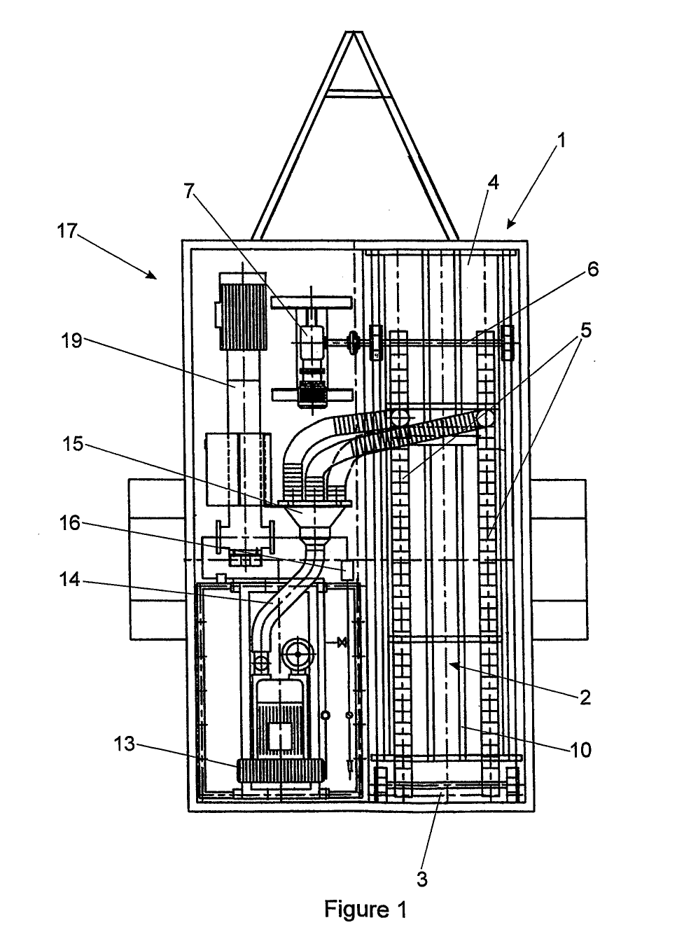

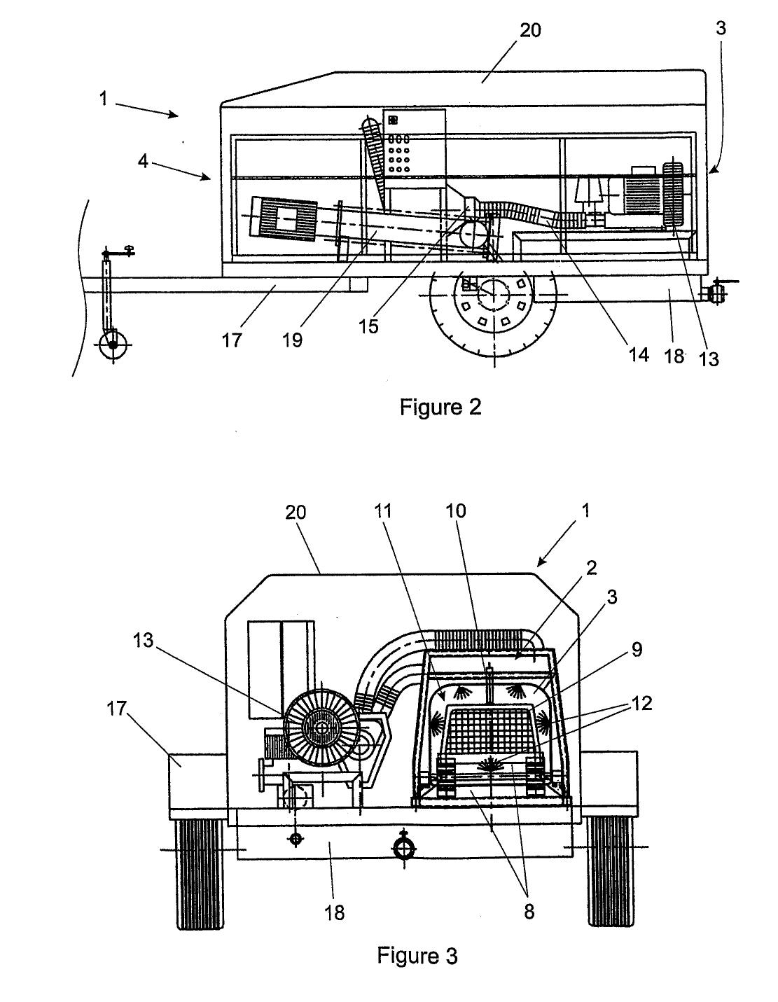

### DETAILED DESCRIPTION WITH REFERENCE TO THE DRAWINGS

In the embodiment of the invention illustrated in the drawings washing apparatus, generally indicated by numeral (1), is particularly adapted, in particular by virtue of its size, for washing handheld shopping baskets. Of course, any other suitably dimensioned baskets may be washed in the apparatus and for different sized baskets, such as those that may be used in the commodity processing field, a suitably enlarged or modified apparatus may be necessary.

Nevertheless, in this particular instance, the washing apparatus comprises a washing tunnel (2) having an entrance end (3) and an exit end (4). A pair of laterally spaced link and pivot conveyors (5) (herein termed chain conveyors for convenience), are driven by co-operating sprockets carried on a drive shaft (6) in turn driven by a variable speed drive motor and gearbox assembly (7). The pair of chain conveyors extends from the entrance end to the exit end of the tunnel.

Substantially all of the components of the conveyors are made of injection moulded plastics material with plastics or stainless steel pins as pivots, as may be required according to the construction and operating environment. The chain conveyors preferably have upstanding flights (8) at predetermined intervals along the length thereof so that the flights ensure movement of the periphery of an adjacent shopping basket along the length of the washing tunnel.

As indicated above, the arrangement is such that shopping baskets (9) are operatively inverted and have their two ends supported one on each of the two chain conveyors. In order to ensure that the shopping baskets are not lifted off the conveyors during passage through the tunnel, retaining means are provided in the form of an elevated skid (10) extending over the path for shopping baskets through the tunnel so as to cooperate with the now uppermost bottoms (11) of the operatively inverted shopping baskets, in use.

A series of spray nozzles (12) is provided within the tunnel so as to be directed to spray high-pressure cleaning liquid over the entire outer surface of the baskets and also upwards from a position between the two conveyors to spray cleaning liquid onto the entire inside surface of the baskets as they proceed through the tunnel. To this end, individual nozzles are directed variously in forward, rearward, lateral and inclined directions in order to achieve this objective.

The washing apparatus further includes drying means in the form of an electrical blower (13) having an air flow pipe (14) which flows into a splitter (15) which, in turn, blows out air at two or more locations near the exit end of the tunnel. The air serves to dry excess cleaning liquid from the shopping baskets after they have been washed. The drying means preferably includes an air filter for removing solid particles from the air. The drying bag could be distributed in any other way, such as, by using a plurality, say four, air knives.

A liquid heater (16) is also preferably provided to heat the cleaning liquid prior to and during use.

In this embodiment of the invention the washing apparatus is mounted on the mobile chassis of a trailer (17) in which instance the washing tunnel preferably extends longitudinally across the length of the mobile chassis from one end to the other. The trailer chassis also supports a holding tank (18) for holding a predetermined quantity of cleaning liquid. Either the top of the holding tank or a separate bottom to the tunnel is formed into a collection facility for directing spent cleaning liquid back to the holding tank to thereby form a substantially closed circuit for the cleaning liquid.

A high-pressure multistage centrifugal pump (19) communicates with the holding tank to draw cleaning liquid from it and supply the nozzles with a supply of suitably high-pressure cleaning liquid. A suitable filter serves to remove solid particles from the cleaning liquid.

The entire assembly of functional components is enclosed within a canopy (20) that has doors at appropriate locations in order to provide access to the functional components and also to provide an entrance and an exit to the tunnel.

It will be understood that, in use, the trailer can be towed from one place to another, typically with the holding tank empty, and that the holding tank can be filled at a place at which a quantity of shopping baskets is to be cleaned. A predetermined quantity of detergent and disinfectant are generally added to the water that is introduced into the holding tank and the high-pressure pump and conveyor are then activated as and when required. Shopping baskets are then placed upside down on the moving conveyor at the entrance end of the conveyor and passed through the tunnel during which time they are subjected to the high-pressure spray emitted by the various nozzles. The flights and skids ensure that the upside down baskets move substantially in unison with the conveyors and the skids prevent the baskets from being lifted or blown off the conveyors by the high-pressure sprays. Spent liquid drains down the tunnel walls and into the collection facility to return to the holding tank.

After an entire batch of shopping baskets has been washed, the cleaning liquid may be discharged to waste and a fresh supply generated for another batch, typically at a different venue.

It will be understood that numerous variations may be made of the embodiment of the invention described above without departing from the scope hereof. In particular, the exact nature of the conveyor means can be varied widely and the pump facility and arrangement of nozzles can be varied according to requirements. Also, it is to be noted that the spacing between the two laterally spaced chain conveyors may be adjustable so that different sizes of shopping baskets can be satisfactorily accommodated whilst causing substantially the entire internal surface to be exposed to the sprays of cleaning liquid. Also, as indicated above, different washing apparatus according to the invention may be constructed for the purpose of washing different sizes of baskets or crates, typically using the commodity processing industry.

1. Washing apparatus for baskets comprising a washing tunnel having an entrance end and an exit end, conveyor means for supporting baskets and conveying them from the entrance end to the exit end of the washing tunnel, and a series of spray nozzles arranged within the tunnel and connected to a source of cleaning liquid that is operatively under pressure, wherein the conveyor means comprises a pair of laterally spaced conveyors arranged to move in unison whilst operatively supporting two opposite peripheral edges of a basket in an inverted orientation as the basket is conveyed from the entrance end to the exit end, and wherein retaining means are provided over at least a part of the length of the washing tunnel to inhibit lifting of baskets off the conveyors.

2. Washing apparatus as claimed in claim 1 in which the laterally spaced conveyors are link and pivot conveyors.

3. Washing apparatus as claimed in claim 2 in which the conveyors are made predominantly of injection molded plastics components.

4. Washing apparatus as claimed in claim 1 in which the conveyors have upstanding flights at predetermined intervals along the length thereof so that the flights ensure movement of the periphery of a basket along the length of the washing tunnel.

5. Washing apparatus as claimed in claim 1 in which the retaining means is one or more elevated skids extending over a path for baskets through the tunnel so as to cooperate with the uppermost bottoms of inverted baskets, in use.

6. Washing apparatus as claimed in claim 1 in which the apparatus has a high-pressure pump for supplying cleaning liquid under pressure to the spray nozzles.

7. Washing apparatus as claimed in claim 1 in which the apparatus includes an electric blower for drying excess cleaning liquid from the baskets.

8. Washing apparatus as claimed in claim 1 in which the washing apparatus is mounted on a mobile chassis.

9. Washing apparatus as claimed in claim 8 in which the chassis is a trailer chassis.

10. Washing apparatus as claimed in claim 8 in which the mobile chassis supports a holding tank for a predetermined quantity of cleaning liquid.

11. Washing apparatus as claimed in claim 10 in which the bottom of the tunnel is formed into a collection facility for directing spent cleaning liquid back to the holding tank thereby forming a substantially closed circuit for the cleaning liquid.

12. Washing apparatus as claimed in claim 1 in which the baskets are handheld shopping baskets and the apparatus is particularly adapted to accommodate such baskets.
